(19) United States
(12) Patent Application Publication
(10) Pub. No.: US 2026/0167394 A1
(43) Pub. Date: Jun. 18, 2026

(54) SUSTAINABLE FLUID DISPENSER ASSEMBLY AND METHODS OF MANUFACURE AND USE THEREOF

(71) Applicant: AMPAC LIMITED, Taicang City (CN)

(72) Inventor: Gary E. MYER, Hillsborough, NJ (US)

(21) Appl. No.: 18/872,013

(22) PCT Filed: May 30, 2023
(86) PCT No.: PCT/US2023/023825

§ 371 Date: Dec. 5, 2024

Related U.S. Application Data
(60) Provisional application No. 63/350,341, filed on Jun. 8, 2022.

(51) Int. Cl. B65D 47/20; A45D 40/22; A47K 5/122

(52) U.S. Cl. CPC B65D 47/2006; A45D 40/22; A47K 5/122

(57) ABSTRACT

A fluid dispenser assemblies having a base with a floor wall having a fluid channel passing therethrough. The base further includes a side wall attached the floor wall. The side wall including a base rotation mechanism. Fluid dispenser assemblies further include a lever having an actuation area and a lever rotation mechanism. The base rotation mechanism and lever rotation mechanism are configured to engage so that the lever can at least partially rotate within the base. The base and the lever are comprised of a sustainable material.

### RELATED APPLICATIONS

This application is a 371 national stage entry of PCT/US2023/023825, filed May 30, 2023, which claims priority to U.S. Provisional App. No. 63/350,341, filed Jun. 8, 2022, the contents of each are incorporated by reference in their entirety.

### FIELD

The present disclosure relates generally to recyclable fluid dispenser assemblies and methods of manufacture and use thereof.

### BACKGROUND

Plastic waste has become a significant environmental problem accounting for up to fourteen percent (14%) of a landfill. This large volume of plastic waste in landfills has a very slow degradation rate, which creates various environmental issues. Despite numerous methods to recycle plastic waste, plastic waste pollution continues to grow and contaminate the earth. Many topical composition products are stored and distributed in single use plastic containers. As a result of structural preferences, chemical compatibility and cost, such single use plastic containers are formed of traditional plastic materials. Designed and sold as single use containers, once all of the topical composition is used, the entire container may be thrown away and is slow to degrade. Therefore, single use fluid dispensers contribute to the plastic waste problem. There remains a need to develop substantially recyclable and optionally biologically-sourced fluid dispensers to help reduce the production and consumption of plastic materials.

### BRIEF SUMMARY

Disclosed herein are various embodiments of a fluid dispenser assembly, comprising: a base comprising a floor wall having a fluid channel passing therethrough, the base further comprising a side wall attached the floor wall, the side wall comprising a base rotation mechanism; and a lever comprising an actuation area and a lever rotation mechanism, wherein the base rotation mechanism and lever rotation mechanism are configured to engage so that the lever can at least partially rotate within the base, wherein the base and the lever are comprised of a sustainable material. In some embodiments, the base and the lever are comprised of the same sustainable material. The fluid dispenser assembly may have about 90% less to about 99% less carbon dioxide emissions than a conventional fluid dispenser assemblies and/or about 15% less to about 30% less plastic waste per piece than a conventional fluid dispenser assembly. In some embodiments, the base rotation mechanism is a recess or hole in the side wall configured to receive the lever rotation mechanism. In one or more embodiments, the lever rotation mechanism is a protrusion configured to be received by the base rotation mechanism. The lever may further comprise an opening configured to dispense a fluid. In some embodiments, the lever has an outer diameter configured to seat within an inner diameter of the side wall. The lever may have a width that is less than an inner diameter of the side wall and a length that approximates an inner diameter of the side wall. According to some embodiments, the sustainable material comprises a bio-degradable material, a polymer, polyethylene, polypropylene, ethylene vinyl alcohol, nylon or combinations thereof. The sustainable material can comprise mono-layers, multi-layers and/or in blends of the bio-degradable material, polymer, polyethylene, polypropylene, ethylene vinyl alcohol, nylon or combinations thereof. In one or more embodiments, the sustainable material comprises one or more polyethylene (e.g., a compound having a plurality of repeating polyethylene groups at the same or different molecular weights). In some embodiments, the one or more polyethylene comprises a molecular weight of about 1,000 Da to about 10,000,000 Da as measured using American Society for Testing and Materials (ASTM) D6474 or ASTM D6474-20. In some embodiments, the material contains polyethylene compounds having different molecular weights. In some embodiments, the sustainable material comprises a biodegradable polymer, a recycled composition or a combination thereof. The sustainable material comprises a recycled resin, a biodegradable plastic a plastic meeting ASTM D6400-04, a polyhydroxyalkanoate (PHA) material or combinations thereof.

In yet further embodiments, disclosed herein are methods, comprising: forming a base comprising a floor wall having a fluid channel passing therethrough, the base further comprising a side wall attached the floor wall, the side wall comprising a base rotation mechanism; forming a lever comprising an actuation area and a lever rotation mechanism; and engaging the base rotation mechanism with lever rotation mechanism so that the lever can at least partially rotate within the base, wherein the base and the lever are comprised of a sustainable material. In some embodiments, forming the base comprises at least one of compression molding or extrusion molding. Forming the lever can include at least one of compression molding or extrusion molding. In some embodiments, the base rotation mechanism is a recess or hole in the side wall and the lever rotation mechanism is a protrusion and engaging comprises receiving the protrusion in the recess or hole.

According to further embodiments, disclosed herein are methods of using a fluid dispenser assembly according to any preceding claim, comprising: attaching a container to the base, wherein the container comprises a cosmetic, moisturizer, sun screen, serum, cream, lotion, gel, lip color, lip moisturizer, lip gloss, blush, foundation, eyeliner, eye shadow, deodorant, antiperspirant, perfume or combinations thereof, or a surface cleaner, wood cleaner, glass cleaner, metal cleaner, stone cleaner, wood moisturizer, surface disinfect, surface duster, surface fragrance or combinations thereof.

### BRIEF DESCRIPTION OF THE DRAWINGS

The present disclosure will be more readily understood from the detailed description of examples presented below considered in conjunction with the attached drawings, of which:

FIG. 1A depicts an embodiment of a base of a sustainable fluid dispenser assembly according to embodiments herein.

FIG. 1B depicts a perspective view of an embodiment of a sustainable fluid dispenser assembly.

FIG. 2A depicts views of an embodiment of a lever 200 of a sustainable fluid dispenser assembly according to embodiments herein.

FIG. 2B depicts a perspective view of an embodiment of a lever 200 of a sustainable fluid dispenser assembly according to embodiments herein.

FIG. 3A depicts a cross-sectional view of a sustainable fluid dispenser assembly according to embodiments herein.

FIG. 3B depicts an alternate view of a sustainable fluid dispenser assembly according to embodiments herein.

FIG. 4A depicts a cross-sectional view of a sustainable fluid dispenser assembly according to embodiments herein.

FIG. 4B depicts an alternate cross-sectional view of a sustainable fluid dispenser assembly according to embodiments herein.

FIG. 4C depicts an alternate cross-sectional view of a sustainable fluid dispenser assembly according to embodiments herein.

FIG. 4D depicts perspective view of a sustainable fluid dispenser assembly according to embodiments herein.

FIG. 5A depicts a top view of a sustainable fluid dispenser assembly according to embodiments herein.

FIG. 5B depicts a side view of a sustainable fluid dispenser assembly according to embodiments herein.

FIG. 5C depicts a cross-sectional view of a sustainable fluid dispenser assembly according to embodiments herein.

FIG. 5D depicts an alternate cross-sectional view of a sustainable fluid dispenser assembly according to embodiments herein.

FIG. 5E depicts an alternate cross-sectional view of a sustainable fluid dispenser assembly according to embodiments herein.

FIG. 5F depicts an alternate cross-sectional view of a sustainable fluid dispenser assembly according to embodiments herein.

FIG. 5G depicts a perspective view of a sustainable fluid dispenser assembly according to embodiments herein.

FIG. 6A depicts a top view of a sustainable fluid dispenser assembly according to embodiments herein.

FIG. 6B depicts a side view of a sustainable fluid dispenser assembly according to embodiments herein.

FIG. 6C depicts a cross-sectional view of a sustainable fluid dispenser assembly according to embodiments herein.

FIG. 6D depicts an alternate cross-sectional view of a sustainable fluid dispenser assembly according to embodiments herein.

FIG. 6E depicts an alternate cross-sectional view of a sustainable fluid dispenser assembly according to embodiments herein.

FIG. 6F depicts an alternate cross-sectional view of a sustainable fluid dispenser assembly according to embodiments herein.

FIG. 6G depicts a perspective view of a sustainable fluid dispenser assembly according to embodiments herein.

FIG. 7 is a flow diagram of a method for manufacturing a sustainable fluid dispenser assembly, including a tube head and disc top, according to some embodiments.

FIG. 8 illustrates graphs associated with fluid dispenser assemblies, according to some embodiments.

### DETAILED DESCRIPTION

### Definitions

Reference throughout this specification to, for example, “one embodiment,” “certain embodiments,” “one or more embodiments,” “in embodiments,” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment,” “in embodiments,” or “in an embodiment” in various places throughout this specification are not necessarily referring to the same embodiment of the invention. Furthermore, the particular features, structures, materials, or characteristics may be combined in any suitable manner in one or more embodiments.

As used herein, the singular forms “a,” “an,” and “the” include plural references unless the context clearly indicates otherwise. Thus, for example, reference to “a lift pin” includes a single lift pin as well as more than one lift pin.

As used herein, the term “about” in connection with a measured quantity, refers to the normal variations in that measured quantity as expected by one of ordinary skill in the art in making the measurement and exercising a level of care commensurate with the objective of measurement and the precision of the measuring equipment. In certain embodiments, the term “about” includes the recited number ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Unless otherwise indicated, all parts and percentages are by weight. Weight percent (wt. %), if not otherwise indicated, is based on an entire composition free of any volatiles, that is, based on dry solids content.

For the purposes of this disclosure, the term “fluid” may refer to a cosmetic as defined by the Federal Food, Drug, and Cosmetic Act (FD&C Act) as “articles intended to be rubbed . . . or otherwise applied to the human body . . . for cleansing, beautifying, promoting attractiveness, or altering the appearance.” 21 U.S.C. § 201(i) (Dec. 11, 2020). In embodiments, the article may be a semi-solid or solid charge, portion, segment, or a stick of a topical composition (e.g., a deodorant, an antiperspirant, a lipstick, a chap stick, a lip gloss, a blush stick, a foundation stick, an eyeliner, an eye shadow or other topical composition), which can be refilled according to embodiments herein.

### Recyclable Fluid Dispenser Assembly

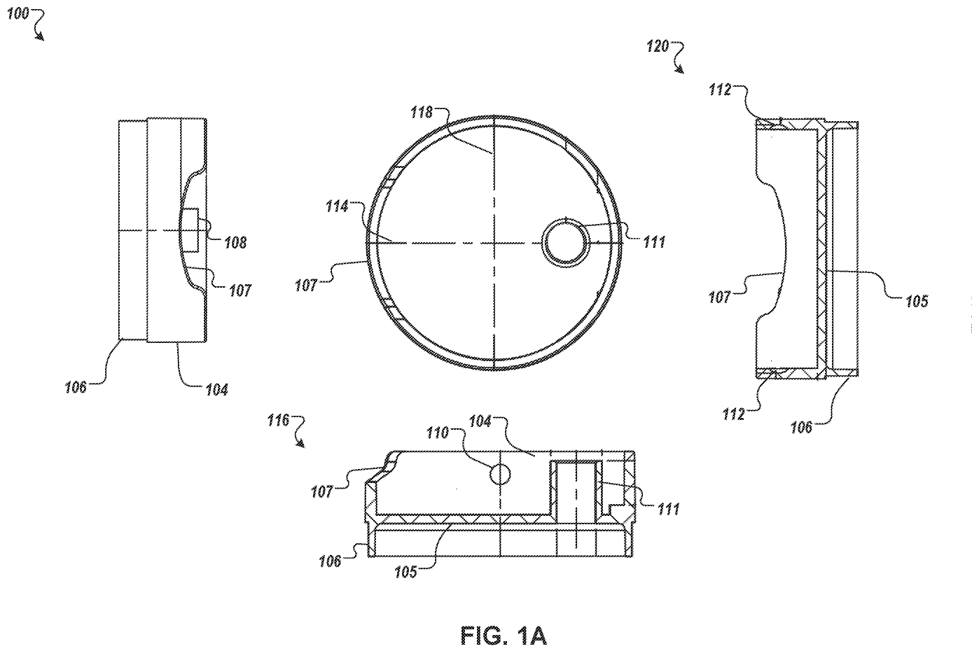

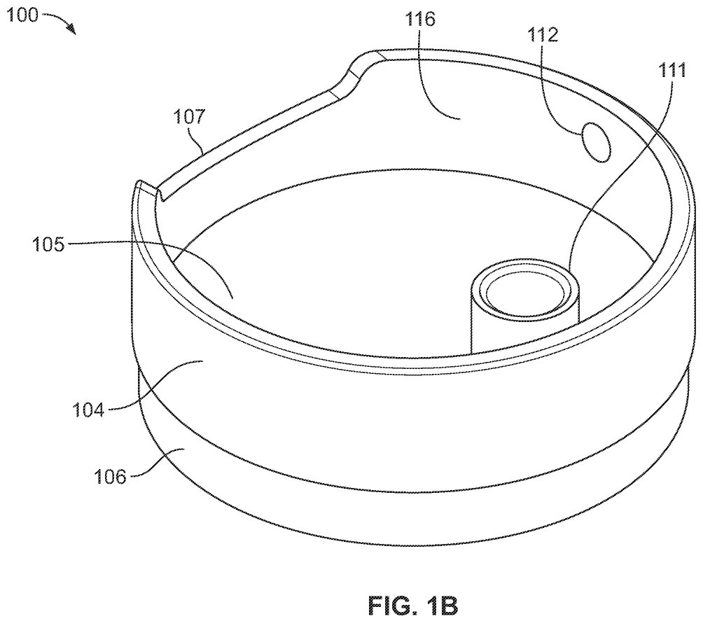

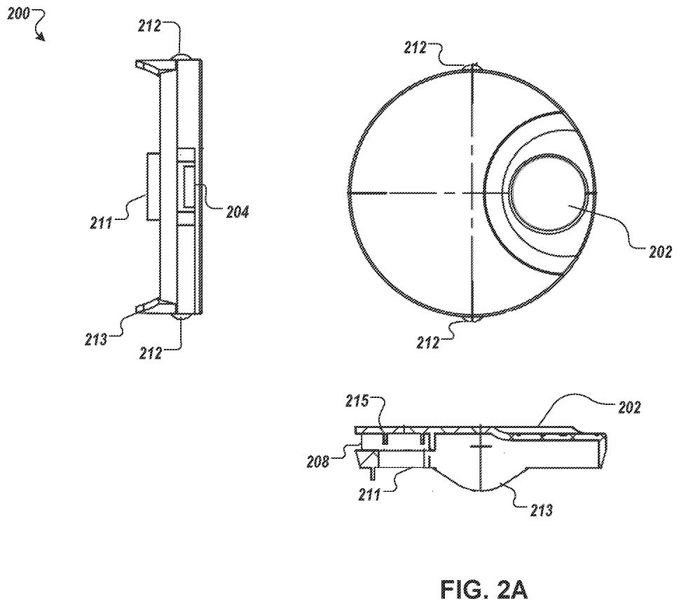

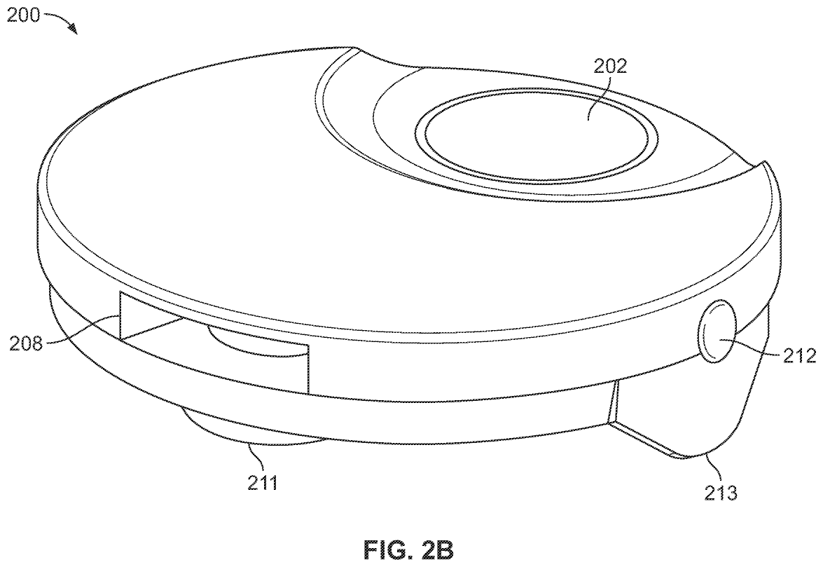

FIGS. 1A and 1B show an embodiment of a base 100 of a sustainable fluid dispenser assembly according to embodiments herein. Fluid dispenser assembly base 100 includes a side wall portion 104 configured to support and engage with a lever (e.g., as shown in FIGS. 2A and 2B). A rotation mechanism of the lever may be configured to engage with a rotation mechanism 110 in side wall 104. The lever can be actuated (e.g., depressed, moved downward, etc.), which causes a dispenser channel of the lever to align with fluid channel 111. When aligned, fluid may flow from a container through fluid channel 111 and out of the fluid dispenser opening. A cutout 107 in side wall 104 enables the lever to be depressed or moved downward during actuation creating a space for, for example, a finger or other mechanism used for actuation.

Base 100 further includes a collar 106 configured to attach to a container (not shown) that stores a fluid according to embodiments herein. A fluid barrier (also referred to herein as a floor, base platform, floor wall) 105 configured to prevent fluid from flowing from an outlet of the container attached thereto and into cavity 116.

FIGS. 2A and 2B show an embodiment of a lever 200 of a sustainable fluid dispenser assembly according to embodiments herein. Lever 200 includes an actuation area 202 that is configured to be depressed, moved downwards or otherwise moved. Lever 200 moves about rotation mechanism 212. Rotation mechanism 212 is configured to engage with a rotation mechanism (e.g., 112) of the base (e.g., 100) of the sustainable fluid dispenser assembly. Dispenser opening 208 is configured to align with fluid channel passage 211 when lever 200 is actuated (e.g., opened). Lever 200 further includes a lever support 213 configured to seat on a fluid barrier (also referred to herein as a floor, base platform, floor wall) of the base. A fluid channel interface 215 is arranged in the passage between the fluid channel passage 211 and the dispenser opening 208.

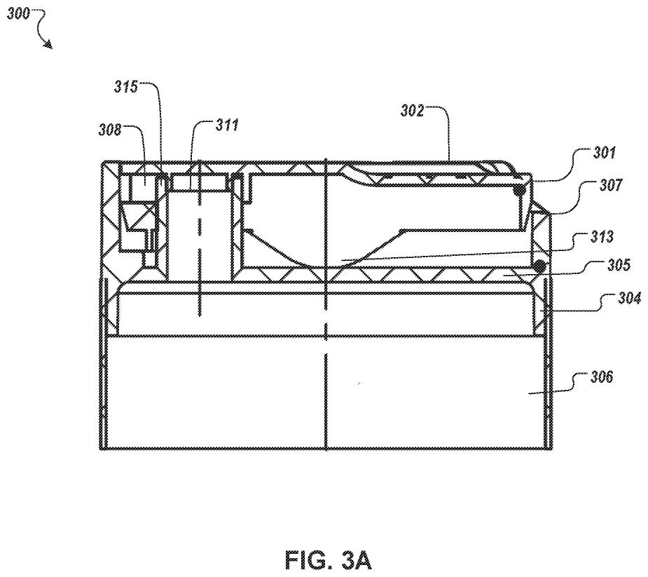

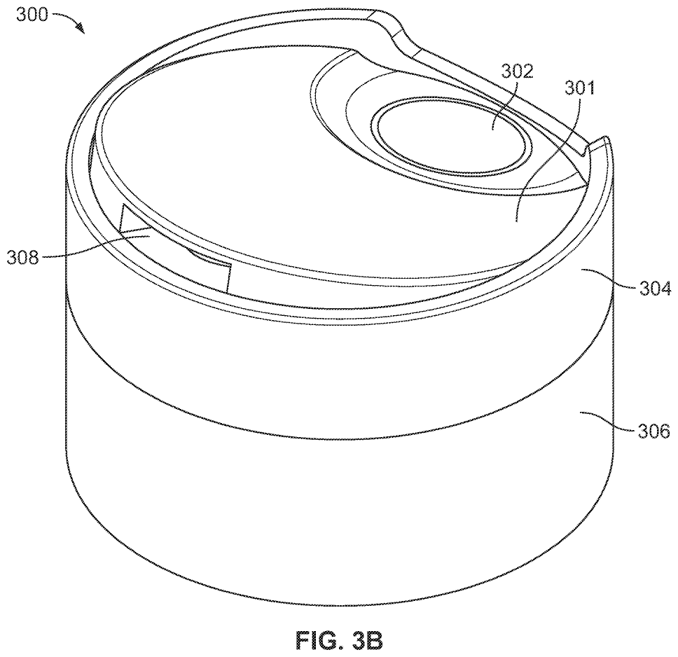

FIGS. 3A and 3B show an embodiment of a sustainable fluid dispenser head assembly 300. Fluid dispenser assembly 300 includes a base portion having a side wall 304 configured to support and engage with lever 301. A rotation mechanism (not shown) of lever 301 may be configured to engage with a rotation mechanism (not shown) in side wall 304. Lever 301 can be actuated (e.g., depressed, moved downward, etc.), which causes dispenser opening 308 to align with fluid channel 311. When aligned, fluid may flow from a container through fluid channel 311 and out of fluid dispenser opening 308. A cutout 307 in side wall 304 enables lever 301 to be depressed or moved downward during actuation creating a space for, for example, a finger or other mechanism used for actuation. A collar 306 is configured to attach to a container (not shown) that stores a fluid according to embodiments herein. A fluid barrier (also referred to herein as a floor, base platform, floor wall) 305 is configured to prevent fluid from flowing through an outlet of the container attached thereto and into a cavity in the base.

Lever 301 includes an actuation area 302 configured to be depressed, moved downwards or otherwise moved. Lever 301 moves about rotation mechanism 312. Rotation mechanism 312 is configured to engage with a rotation mechanism of the base of the sustainable fluid dispenser assembly. Dispenser opening 308 is configured to align with fluid channel passage 311 when lever 301 is actuated (e.g., opened). Lever 301 further includes a lever support 313 configured to seat on a fluid barrier of the base. A fluid channel interface 315 is arranged in the passage between the fluid channel passage 311 and the dispenser opening 308.

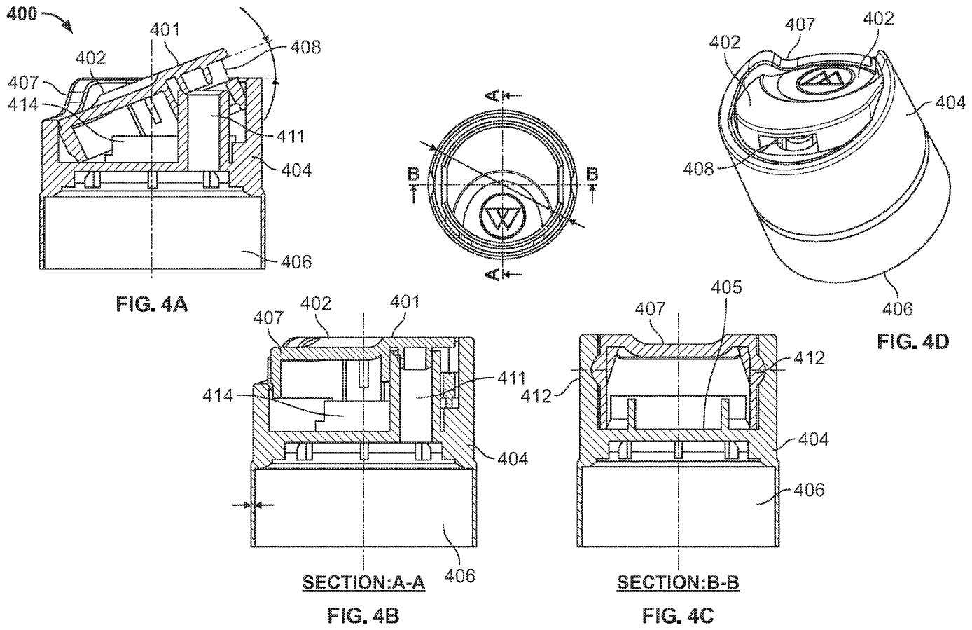

FIGS. 4A-4D show an embodiment of a fluid dispenser assembly 400 including a tube head and disc top. Fluid dispenser assembly 400 includes a base portion having a side wall 404 configured to support and engage with lever 401. A rotation mechanism (not shown) of lever 401 may be configured to engage with a rotation mechanism (not shown) in side wall 404. Lever 401 can be actuated (e.g., depressed, moved downward, etc.), which causes dispenser opening 408 to align with fluid channel 411. When aligned, fluid may flow from a container through fluid channel 411 and out of fluid dispenser opening 408. A cutout 407 in side wall 404 enables lever 401 to be depressed or moved downward during actuation creating a space for, for example, a finger or other mechanism used for actuation. A collar 406 is configured to attach to a container (not shown) that stores a fluid according to embodiments herein. A fluid barrier (also referred to herein as a floor, base platform, floor wall) 405 is configured to prevent fluid from flowing through an outlet of the container attached thereto and into a cavity in the base.

Lever 401 includes an actuation area 402 configured to be depressed, moved downwards or otherwise moved. Lever 401 moves about rotation mechanism 412. Rotation mechanism 412 is configured to engage with a rotation mechanism of the base of the sustainable fluid dispenser assembly. Dispenser opening 408 is configured to align with fluid channel passage 411 when lever 401 is actuated (e.g., opened). Lever 401 further includes a lever support 413 configured to seat on a fluid barrier of the base. A fluid channel interface 415 is arranged in the passage between the fluid channel passage 411 and the dispenser opening 408.

Fluid dispenser assembly 400 differs from fluid dispenser assembly 300 in that side wall 404 has a thicker vertical dimension. Fluid dispenser assembly 400 also does not include lever support 313.

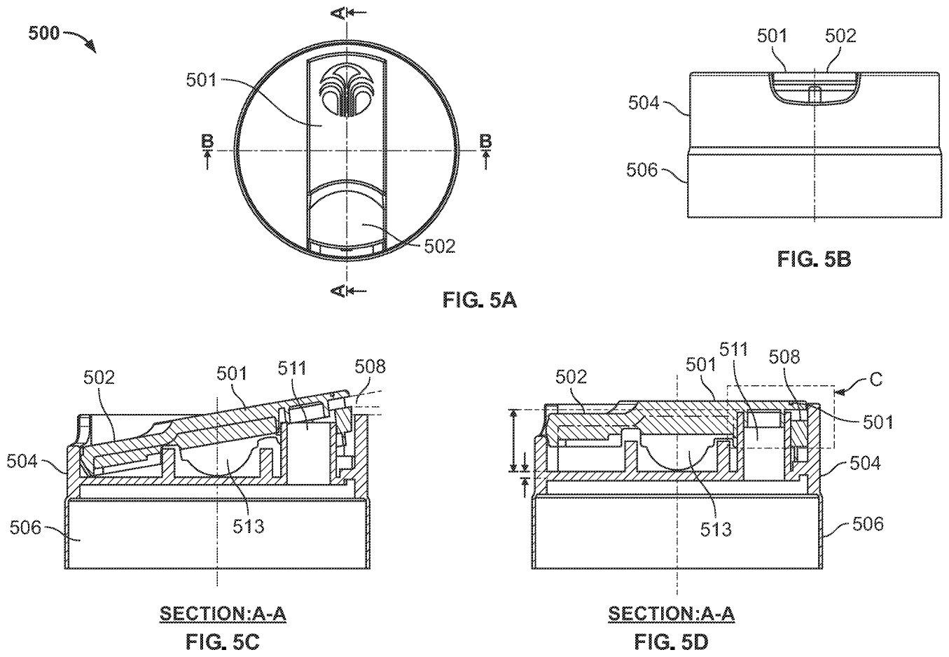

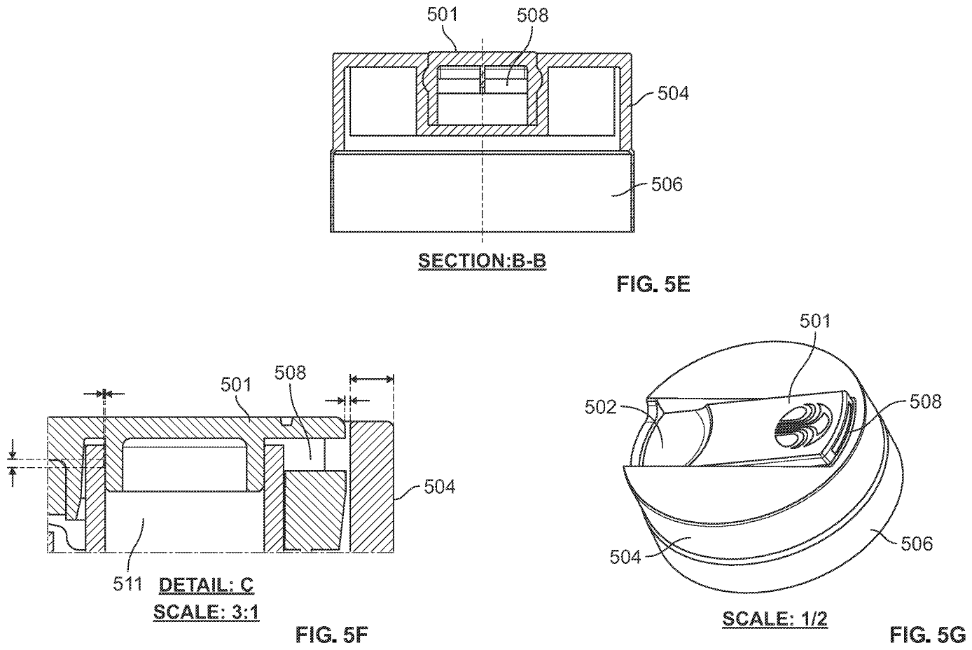

FIGS. 5A-5G show an embodiment of a fluid dispenser assembly 500 including tube head and disc top. Fluid dispenser assembly 500 includes a base portion having a side wall 504 configured to support and engage with lever 501. A rotation mechanism (not shown) of lever 501 may be configured to engage with a rotation mechanism (not shown) in side wall 504. Lever 501 can be actuated (e.g., depressed, moved downward, etc.), which causes dispenser opening 508 to align with fluid channel 511. When aligned, fluid may flow from a container through fluid channel 511 and out of fluid dispenser opening 508. A cutout 507 in side wall 504 enables lever 501 to be depressed or moved downward during actuation creating a space for, for example, a finger or other mechanism used for actuation. A collar 506 is configured to attach to a container (not shown) that stores a fluid according to embodiments herein. A fluid barrier (also referred to herein as a floor, base platform, floor wall) 505 is configured to prevent fluid from flowing through an outlet of the container attached thereto and into a cavity in the base.

Lever 501 includes an actuation area 502 configured to be depressed, moved downwards or otherwise moved. Lever 501 moves about rotation mechanism 512. Rotation mechanism 512 is configured to engage with a rotation mechanism of the base of the sustainable fluid dispenser assembly. Dispenser opening 508 is configured to align with fluid channel passage 511 when lever 501 is actuated (e.g., opened). Lever 501 further includes a lever support 513 configured to seat on a fluid barrier of the base. A fluid channel interface 515 is arranged in the passage between the fluid channel passage 511 and the dispenser opening 508.

Fluid dispenser assembly 500 differs from fluid dispenser assemblies 300 and 400 in that lever 501 is narrower and does not take up the entire area of the top. Lever 501 is rectangular whereas levers 301, 401 are circles.

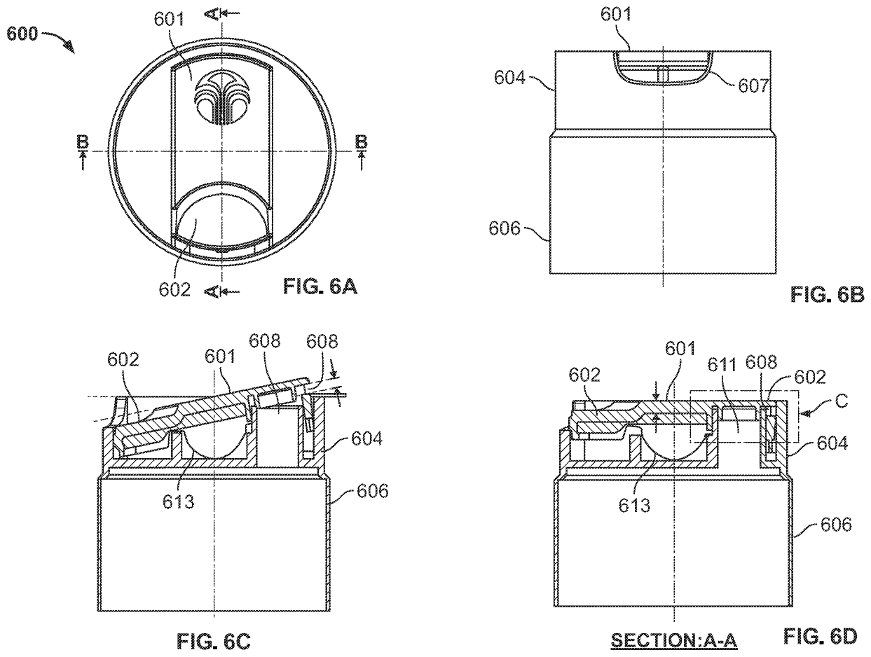

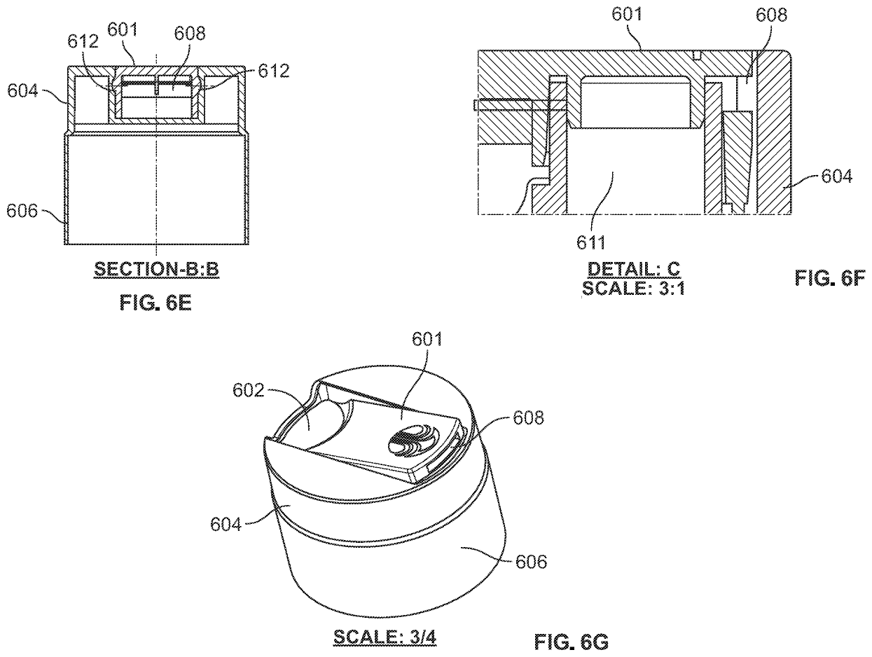

FIGS. 6A-6G show an embodiment of a fluid dispenser assembly 600 including tube head and disc top. Fluid dispenser assembly 600 includes a base portion having a side wall 604 configured to support and engage with lever 601. A rotation mechanism (not shown) of lever 601 may be configured to engage with a rotation mechanism (not shown) in side wall 604. Lever 601 can be actuated (e.g., depressed, moved downward, etc.), which causes dispenser opening 608 to align with fluid channel 611. When aligned, fluid may flow from a container through fluid channel 611 and out of fluid dispenser opening 608. A cutout 607 in side wall 604 enables lever 601 to be depressed or moved downward during actuation creating a space for, for example, a finger or other mechanism used for actuation. A collar 606 is configured to attach to a container (not shown) that stores a fluid according to embodiments herein. A fluid barrier (also referred to herein as a floor, base platform, floor wall) 605 is configured to prevent fluid from flowing through an outlet of the container attached thereto and into a cavity in the base.

Lever 601 includes an actuation area 602 configured to be depressed, moved downwards or otherwise moved. Lever 601 moves about rotation mechanism 612. Rotation mechanism 612 is configured to engage with a rotation mechanism of the base of the sustainable fluid dispenser assembly. Dispenser opening 608 is configured to align with fluid channel passage 611 when lever 601 is actuated (e.g., opened). Lever 601 further includes a lever support 613 configured to seat on a fluid barrier of the base. A fluid channel interface 615 is arranged in the passage between the fluid channel passage 611 and the dispenser opening 608.

Fluid dispenser assembly 600 differs from fluid dispenser assemblies 300 and 400 in that lever 601 is narrower and does not take up the entire area of the top. Lever 601 is rectangular whereas levers 301, 401 are circles. Fluid dispenser assembly 600 differs from fluid dispenser assembly 500 in that collar 606 is thicker, having a higher vertical height than collar 506.

Sustainable materials suitable for components (e.g., flexible plastic tubes, collars, flow passages, etc.) of the fluid dispenser assemblies according to embodiments herein include, but are not limited to, flexible materials, biodegradable polymers, polymers, polyethylene (PE), polypropylene (PP), ethylene vinyl alcohol (EVOH), nylon and combinations thereof. In some embodiments, the components can be constructed of materials in mono-layers, multi-layers and/or in blends of materials to provide a complete range of flexibility and protective barrier. In some embodiments, the materials suitable for the components (e.g., tubes, collars, collars, flow passages, etc.) of fluid dispenser assemblies according to embodiments herein include, but are not limited to, polyethylene in various blends and/or having various molecular weights. According to one or more embodiments, polyethylene utilized for materials of components of the fluid dispenser assemblies as described herein can have a molecular weight of about 1,000 Da to about 10,000,000 Da, about 2,000 Da to about 8,000,000 Da, about 5,000 Da to about 5,000,000 Da, about 10,000 Da to about 1,000,000, about 20,000 Da to about 800,000 Da, about 50,000 Da to about 500,000 Da or any individual molecular weight or sub-range within these ranges as measured using American Society for Testing and Materials (ASTM) D6474 or ASTM D6474-20.

In one or more embodiments, the sustainable material a biodegradable polymer, a recycled composition or a combination thereof. For example, the threaded mechanism 203, the cup 207, the at least one fastener 212, the upper collar 204, the collar member 205, the outer base 201 and the outer cap 210 is each independently constructed of at least one of a biodegradable polymer or a recycled composition such as a recycled resin. For example, biodegradable plastics could be used, i.e., plastics meeting ASTM D6400-04 Standard Specification for Compostable Plastics. Desirably, a biodegradable plastic is fully biodegradable, and is not merely fragmented into very small particles upon biodegradation. An example of such fully biodegradable plastic can be polyhydroxyalkanoate (PHA) materials.

Sustainable fluid dispenser assemblies according to various embodiments herein provide less carbon dioxide emissions than conventional fluid dispenser assemblies. In some embodiments, sustainable fluid dispenser assemblies according to one or more embodiments have about 99% less, about 98% less, about 97% less, about 96% less, about 95% less, about 94% less, about 93% less, about 92% less, about 91% less, about 90% less, about 85% less, about 80% less carbon dioxide emissions than conventional fluid dispenser assemblies, or any individual value or sub-range within these ranges. In some embodiments, the fluid dispenser assembly has about 80% less to about 99%, or any individual value or sub-range within this range, less carbon dioxide emissions than a conventional fluid dispenser assemblies.

Sustainable fluid dispenser assemblies according to various embodiments herein provide less plastic waste per piece as compared to conventional fluid dispenser assemblies. In some embodiments, sustainable fluid dispenser assemblies according to one or more embodiments result in about 30% less, about 29% less, about 28% less, about 27% less, about 26% less, about 25% less, about 24% less, about 23% less, about 22% less, about 21% less, about 20% less, about 19% less or about 15% less plastic waste per piece than conventional fluid dispenser assemblies, or any individual value or sub-range within these ranges.

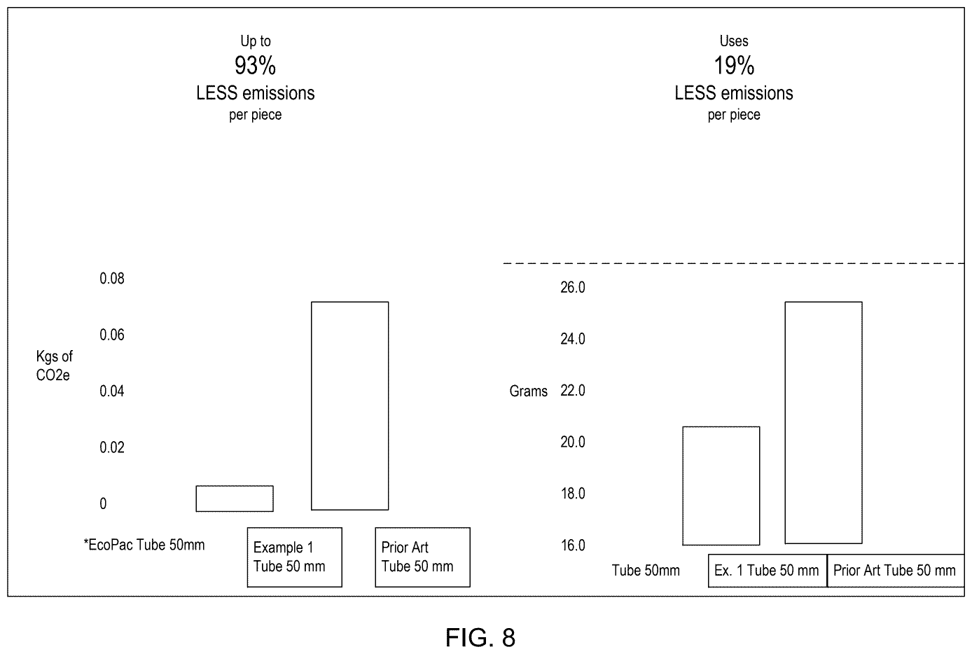

According to some embodiments, the sustainable fluid dispenser assembly comprises fewer, for example, three less, two less or one less component than prior art flexible tubes using a standard closure system that screws or snaps onto the molded tube head. This results in significantly less material than current plastic tube manufacturing processes. In one example, Example 1 (e.g., see FIG. 8), a sustainable fluid dispenser assembly according to embodiments herein resulted in a 93% reduction in carbon dioxide (CO₂) emissions as compared to a known fluid dispenser assembly as shown in the below chart. The sustainable fluid dispenser assembly of Example 1 (e.g., see FIG. 8) also resulted in about 19% less plastic per piece than a known fluid dispenser assembly.

According to one or more embodiments, all components of the sustainable fluid dispenser assembly may be manufactured from the same material, which simplifies the ease of recycling with no disassembly required by the consumer. Conventional fluid dispensers often use a combination of a first polymer to mold the sleeve and tube head and a second polymer to form the closure and dispensing system.

### Methods of Manufacturing

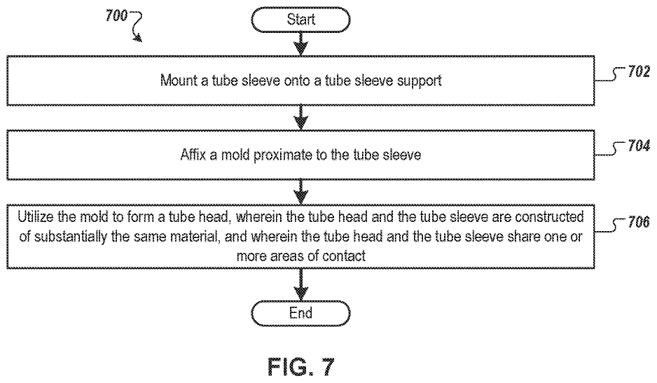

FIG. 7 is a flow diagram of a method for manufacturing a fluid dispenser 700 including a tube head and disc top, according to some embodiments. At block 702 the method 700 includes mounting a tube sleeve onto a tube sleeve support.

At block 704 method 700 includes affixing a mold proximate to the tube sleeve. At block 706, method 700 further includes utilizing the mold to form a tube head. The tube head and tube sleeve may be constructed of substantially the same material. In some embodiments, the tube head and the tube sleeve share one or more areas of contact.

In some embodiments, components of sustainable fluid dispenser assemblies as described herein can be formed using injection molding and/or extrusion molding. In some embodiments, the rigid lever and base components can be formed by injection molding. In some embodiments, the tube sleeves and/or containers can be formed using extrusion molding. In some embodiments, the method can include molding molten plastic, under pressure, to form the desired shape. After manufacturing the tube sleeve, the sleeve is mounted onto a mandrel and clamped within an injection mold. This injection mold forms the tube head welding it to the tube sleeve because of both components being of the same material. Lever components then snap together without other mechanical joining or adhesive that will seal the formula in the finished tube and dispense the product when opened.

### Methods of Use

Sustainable fluid dispenser assemblies according to embodiments herein are suitable for use as container heads for dispensing fluids. Such containers include, but are not limited to, bottles, vials, pouches, jars and balloons. According to one or more embodiments, the containers may be formed of a flexible material enabling the container to be squeezed or compressed to increase force and/or pressure on a fluid therein. Such force and/or pressure can cause the fluid to flow upward toward the sustainable fluid dispenser assembly head and through a flow passage therein serving as storage cap and an outlet for the container system. In some embodiments, the containers may include an internal component (e.g., a pump, an elevator platform, etc.) coupled to an actuation mechanism (e.g., a button, spring, syringe, etc.) that causes the fluid to flow up through the container, to the sustainable fluid dispenser assembly head and through a flow passage therein.

During use, the push level may be depressed causing the disc top to rotate on a hinge. The rotation causes the fluid passage within the disc top to align with the open head of the container attached thereto. Fluid may then flow from the container and through the fluid passage of the disc top. The fluid exiting the fluid passage of the sustainable fluid dispenser assembly may then be applied to a surface as needed and/or directed.

Fluids suitable for containing and/or dispensing using sustainable fluid dispenser assemblies as described herein include liquids, slurries, viscous liquids, pastes, Bingham plastics, etc. In one or more embodiments, suitable fluids may be configured to be rubbed, poured, introduced into, or otherwise applied to a surface. In some embodiments, the surface is, for example, skin and the fluid is applied, for example, to cleanse, beautify, promote attractiveness, and/or alter appearance. In some embodiments, the surface is, for example, an inanimate surface and the fluid is applied, for example, to clean, polish, moisturize, deodorize, disinfect, dust, etc.

Suitable fluids include, but are not limited to, cosmetics and household cleaners. Suitable cosmetics include, but are not limited to, a cosmetic, moisturizer, sun screen, serum, cream, lotion, gel, lip color, lip moisturizer, lip gloss, blush, foundation, eyeliner, eye shadow, deodorant, antiperspirant and/or perfume. Suitable household cleaners include, but are not limited to, surface cleaners, wood cleaners, glass cleaners, metal cleaners, stone cleaners, wood moisturizers, surface disinfects, surface dusters, surface fragrances and/or combinations thereof.

Although exemplary systems have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

One having ordinary skill in the art will appreciate that the size, shape and placement of such structures can be varied depending on the particular application. Apart from the functional aspects the structures provide, they also provide a novel decorative element. One having ordinary skill in the art will appreciate the decorative possibilities such shapes present.

The foregoing description, for purposes of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best utilize the disclosure and various examples with various modifications as may be suited to the particular use contemplated.

1. A fluid dispenser assembly, comprising:
a base comprising a floor wall having a fluid channel passing therethrough, the base further comprising a side wall attached the floor wall, the side wall comprising a base rotation mechanism; and
a lever comprising an actuation area and a lever rotation mechanism, wherein the base rotation mechanism and lever rotation mechanism are configured to engage so that the lever can at least partially rotate within the base,
wherein the base and the lever are comprised of a sustainable material.

2. The fluid dispenser assembly of claim 1, wherein the base and the lever are comprised of the same sustainable material.

3. The fluid dispenser assembly of claim 1, wherein the fluid dispenser assembly has about 90% less to about 99% less carbon dioxide emissions than a conventional fluid dispenser assemblies.

4. The fluid dispenser assembly of claim 1, wherein the fluid dispenser assembly comprises about 15% less to about 30% less plastic waste per piece than a conventional fluid dispenser assembly.

5. The fluid dispenser assembly of claim 1, wherein the base rotation mechanism is a recess or hole in the side wall configured to receive the lever rotation mechanism.

6. The fluid dispenser assembly of claim 1, wherein the lever rotation mechanism is a protrusion configured to be received by the base rotation mechanism.

7. The fluid dispenser assembly of claim 1, wherein the lever further comprises an opening configured to dispense a fluid.

8. The fluid dispenser assembly of claim 1, wherein the lever has an outer diameter configured to seat within an inner diameter of the side wall.

9. The fluid dispenser assembly of claim 1, wherein the lever comprises a width that is less than an inner diameter of the side wall and a length that approximates an inner diameter of the side wall.

10. The fluid dispenser of claim 1, wherein the sustainable material comprises a bio-degradable material, a polymer, polyethylene, polypropylene, ethylene vinyl alcohol, nylon or combinations thereof.

11. The fluid dispenser of claim 1, wherein the sustainable material comprises mono-layers, multi-layers and/or in blends of the bio-degradable material, polymer, polyethylene, polypropylene, ethylene vinyl alcohol, nylon or combinations thereof.

12. The fluid dispenser of claim 1, wherein the sustainable material comprises one or more polyethylene.

13. The fluid dispenser assembly of claim 12, wherein the one or more polyethylene comprises a molecular weight of about 1,000 Da to about 10,000,000 Da as measured using American Society for Testing and Materials (ASTM) D6474 or ASTM D6474-20.

14. The fluid dispenser assembly according to claim 1, claim, wherein the sustainable material comprises a biodegradable polymer, a recycled composition or a combination thereof.

15. The fluid dispenser assembly according to claim 1, claim, wherein the sustainable material comprises a recycled resin, a biodegradable plastic a plastic meeting ASTM D6400-04, a polyhydroxyalkanoate (PHA) material or combinations thereof.

16. A method, comprising:
forming a base comprising a floor wall having a fluid channel passing therethrough, the base further comprising a side wall attached the floor wall, the side wall comprising a base rotation mechanism;
forming a lever comprising an actuation area and a lever rotation mechanism; and
engaging the base rotation mechanism with lever rotation mechanism so that the lever can at least partially rotate within the base,
wherein the base and the lever are comprised of a sustainable material.

17. The method of claim 16, wherein forming the base comprises at least one of compression molding or extrusion molding.

18. The method of claim 16, wherein forming the lever comprises at least one of compression molding or extrusion molding.

19. The method of claim 16, wherein the base rotation mechanism is a recess or hole in the side wall and the lever rotation mechanism is a protrusion and engaging comprises receiving the protrusion in the recess or hole.

20. (canceled)
